(19) United States
(12) Patent Application Publication
(10) Pub. No.: US 2010/0132631 A1
(43) Pub. Date: Jun. 3, 2010

(54) PROTECTIVE ANIMAL GARMENT

(76) Inventor: Wendy Walker-Algaze, Irving, TX (US)

Correspondence Address: Myers Wilson P.C., 16660 Dallas Parkway, Suite 2500, Dallas, TX, 75248, US

(21) Appl. No.: 12/581,779

(22) Filed: Oct. 19, 2009

Related U.S. Application Data
(60) Provisional application No. 61/106,237, filed on Oct. 17, 2008.

(51) Int. Cl. A01K 13/00

(52) U.S. Cl. 119/850; 119/863

(57) ABSTRACT

A configurable animal garment comprising at least one piece of material constructed of lightweight, resilient fabric of sufficient size and shape to adequately cover a substantial portion of a four legged animal, and providing openings for the head, tail, genitalia and the four legs of said animal when fastened; and a means for attaching said at least one piece together to form a wearable garment

### CROSS-REFERENCE TO RELATED APPLICATIONS

Provisional Application: U.S. Patent Application No. 61/106,237 filed Oct. 17, 2008, and entitled “Protective Animal Garment.”

### TECHNICAL FIELD

The present invention relates to protective garments for animals and, in particular, to a protective garment providing coverage and protection from external elements for domestic pets, such as dogs.

### DESCRIPTION OF PRIOR ART

Protective garments for animals are well-known in the art. Most have as their primary objective protection of an animal from exterior (weather) or interior (body wastes) elements. Such prior art garments are constructed from a variety of materials, and utilize various different fastening means, such as hook-and-loop type fasteners. Materials used in prior art pet garments vary widely depending upon the specifics of the garment. Sonic prior art devices employ water repellent materials in an effort to protect the animal from the elements. Others include thermally insulated materials in an effort to retain body heat of the animal. Still others employ specially designed wicking materials in an effort to provide a protective garment (e.g., a diaper) against the products of the animal's bodily functions. Regardless of primary objective, most such devices only attempt to cover or protect the core or torso of the animal's body. As a result, other portions of the animal, such as the appendages (legs and paws), are left unprotected and exposed to the elements. Importantly, it is these non-core areas of the animal that often require the most protection. There remains a need in the art for a garment that will provide protection from external elements for a greater portion of the animal's body.

### SUMMARY OF THE INVENTION

The present invention provides a protective garment for domestic animals having four legs of various sizes and shapes. Importantly, the invention covers a substantial portion of the body of the animal to be protected, including, without limitation, the legs and feet of the animal. Alternatively, portions of the animal unlikely to come into contact with physical elements (e.g., snow, mud, wet ground, burs, etc.) can remain uncovered, if desired. For purposes of illustration only, the present invention garment will be described herein for use with a domestic pet, such as a dog. While the invention described herein is specifically described in the context of, and directed to, a dog, it is noted that the invention may be readily used with many different animals (e.g., cats, ferrets, horses, etc.).

The garment of the present invention is preferably constructed of a lightweight, flexible material that can (preferably simultaneously) hold in body heat and keep out the elements (e.g., snow, sleet and rain). Other preferable characteristics for the material comprising the present invention garment include: washable and durable. A non-exhaustive list of appropriate materials, used alone or in combination, include: canvas, leather, nylon, cotton, fleece, polyester and acetate. The selection of material(s) for any embodiment will be dictated in part by the primary objective of that embodiment. Additionally, nanotechnology-based smart fabric textiles can he utilized in connection with the garment of this invention, if desired. Examples of such materials include c-change™, available from Schoeller-Textil ACC (Sevelen, Switzerland). Such materials are capable of “reacting” (e.g., phase changing molecular structures) to temperature and other changes in the environment to provide additional comfort and protection by the garment. The garment can be constructed of one more layers or plies of such materials, and can be further padded, if desired, to protect the clog from extreme weather conditions.

In a preferred embodiment, the present invention garment comprises two or more pieces which are fastened to each other to form a wearable garment for the dog, to provide an appropriate level of physical barrier to external elements to which the dog will be subjected. In this embodiment, there is a main body piece, shaped and sized to accept the four legs of the dog and tit snugly around the torso of the dog, preferably extending from just above the paws of the dog along each leg up across the sides of the dog and to the edge of the back of the dog. Optional foot pieces and a back piece (that would span the back of the dog left uncovered by the main body piece) could be utilized, if desired, depending upon the level and nature of external elements from which the owner wants to protect the dog. For example, if a dog is going to be exposed to snow-covered ground on an outing, but the current weather does not include falling precipitation, only the main body piece of the garment covering the dog's sides and legs might be utilized. Utilizing this configuration, the torso, sides and legs of the dog would be protected from the snow and associated mud, slush, and the like. The optional feet pieces could also be utilized in this situation to more fully protect the dog from the external elements. If, however, the dog will also be subjected to falling precipitation, then the additional back piece can also be employed to provide additional protection for the dog (both by retaining additional body heat and by repelling the falling precipitation). In another example, in which the only adverse elements to which the dog will be exposed on a particular outing is vegetation including spines, hooks, “cockaburs”, “sticktites”, and the like, only the main body piece and the feet pieces of the garment might be employed to provide the appropriate level of protection.

The various pieces of the garment may be fastened together via use of any appropriate fastening device, but, preferably, via use of hook-and-loop fastening strips (e.g., Velcro® brand hook-and-loop fasteners). For example, the main body piece of garment may be fastened across the back of the dog to itself to form a wearable garment. Optional pieces, such as the back piece, may be likewise fastened to the main body piece and/or to themselves to provide additional protection of the dog.

Other optional features of the garment include: use of water-repellent fabric or material to repel precipitation; and/or use of heat reflective fabric or material to reflect away heat from the sun, cooling animal; and/or use of colored or printed/patterned fabric or material to provide greater visibility (bright colors), less visibility (camouflage for hunting contexts), or various desired aesthetic results (matching or complimenting the owner's clothing); and/or use of elastic or other gathering means at the terminal points of the pieces of the garment to provide a more tailored fit at certain points of the animal (e.g., at the feet); and/or use of inexpensive, biodegradable materials to provide a disposable embodiment of the present invention garment.

The garment of the present invention is highly configurable, and could be sold in various styles or embodiments (e.g., directed towards types of inclement weather conditions) or as a kit in which several embodiments could he assembled by combining/configuring components provided in the kit.

### BRIEF DESCRIPTION OF THE DRAWINGS

FIGS. 1 : Drawing of “D-O-GEE Wear” invention. A snow-suit garment for dogs, intended to keep dogs warm, and to provide protection from the elements. Made of water resistant fabric, Velcro, snaps, and elastic.

FIG. 1A: An opening in the garment for the dog's tail, and use of bathroom.

FIG. 1B: Opening in garment for use of bathroom.

FIG. 1C: Removable stomach covering, fastened to garment by snaps. Elastic lining ensures that snow does not get into the garment.

FIG. 1D: Opening in garment for dog's head. Elastic lining around neck ensures that snow does not get into the garment.

FIG. 1E: Elastic straps fastened to garment and held in place by fabric “loops.” Straps can be loosened or tightened around dogs ankles accordingly to ensure that snow does not get into garment through the foot opening.

FIG. 2: Posterior view of the dog wearing the present invention garment. Drawing of dog wearing “D-O-GEE Wear” invention with the removable, hack covering taken off.

FIG. 2A: Posterior view of the dog wearing the present invention garment. Fastening strap made of fabric and Velcro, which holds “D-O-GEE Wear” garment in place.

FIG. 2B. Posterior view of the dog wearing the present invention garment. Elastic straps fastened to garment and held in place by fabric “loops.” Straps can be loosened or tightened around dogs ankles accordingly to ensure that snow does not get into garment through the foot opening.

FIG. 2C: Posterior view of the dog wearing the present invention garment. Removable stomach covering, fastened to garment by snaps. Elastic lining ensures that snow does not get into the garment.

FIG. 2D: Posterior view of the dog wearing the present invention garment. Fastening strap made of fabric and Velcro. Supports garment such that the opening for the tail and bathroom use is allowed.

FIG. 2E: Posterior view of the dog wearing the present invention garment. Fabric stripe made of light reflective material goes down entire side of “D-O-GEE Wear” garment. Stripe is not only stylistically appealing, but also serves as a means to keep dog visible to cars in the dark as well.

FIG. 3: Posterior view of the dog wearing the present invention garment. Drawing of dog wearing “D-O-GEE Wear” garment.

FIG. 3A: Posterior view of the dog wearing the present invention garment. An opening in the garment for the dog's tail, and use of bathroom.

FIG. 3B: Posterior view of the dog wearing the present invention garment. Opening in garment for use of bathroom.

FIG. 3C: Posterior view of the dog wearing the present invention garment. Removable stomach covering, fastened to garment by snaps. Elastic lining ensures that snow does not get into the garment.

FIG. 3D: Posterior view of the dog wearing the present invention garment. Opening in garment for dog's head. Elastic lining around neck ensures that snow does not get into the garment.

FIG. 3E: Elastic straps fastened to garment and held in place by fabric “loops.” Straps can be loosened or tightened around dogs ankles accordingly to ensure that snow does not get into garment through the foot opening.

FIG. 4: A photograph of “D-O-GEE Wear” garment invention in various sizes. Note the decorative “D-O-GEE Wear” logo, the decorative stripes made of light-reflective fabric, and the adjustable straps around each foot opening of the garment.

FIG. 5: Posterior view of the dog wearing the present invention garment. A photograph of a dog wearing the “D-O-GEE Wear” garment invention.

FIG. 6: Posterior view of the dog wearing the present invention garment. A photograph of a dog wearing the “D-O-GEE Wear” garment invention with the removable back covering taken off.

FIG. 7: A photograph of the “D-O-GEE Wear” garment invention.

FIG. 8: A photograph of the “D-O-GEE Wear” garment invention with special attention to logo detail.

FIG. 9: A lateral view of a dog wearing an embodiment of the present invention garment. In this embodiment, the garment of the present invention was configured to only utilize the main body piece and the feet pieces such that the back of the dog was left exposed (desirable to keep the dog from overheating due to exercise, etc.);

FIG. 10. A posterior view of the dog wearing the present invention garment. This photograph shows the shaping of the main body piece to provide openings at the appropriate locate for the tail of the dog to protrude from the garment: and

FIG. 11: Illustrates the dog wearing an embodiment of the present invention garment including the back piece. This embodiment shows how the main body portion is shaped to provide an opening for the genitalia of the dog, and also demonstrates the fastening of the back piece to the upper edges of the main body piece to form a more protective embodiment of the garment.

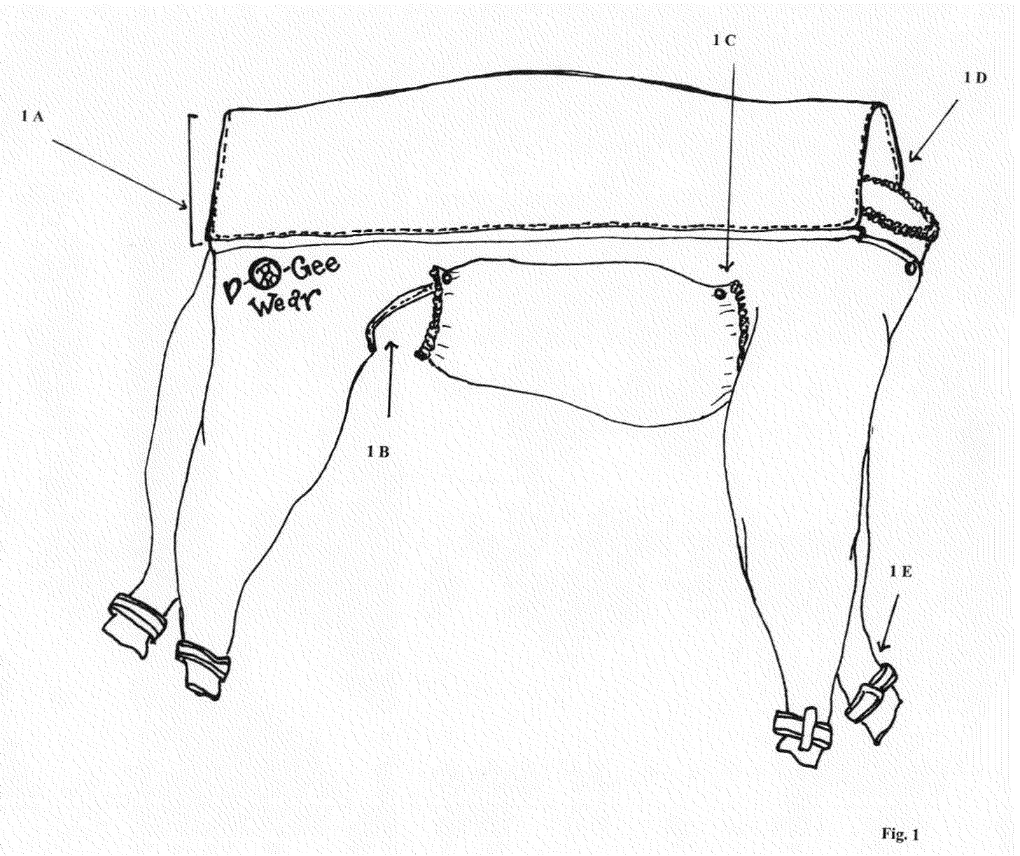

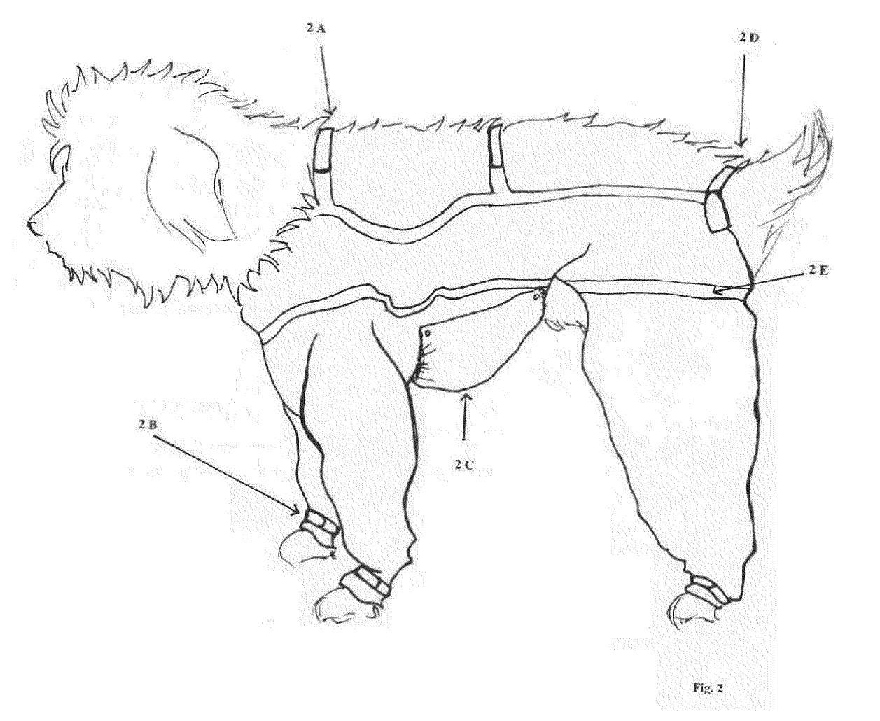

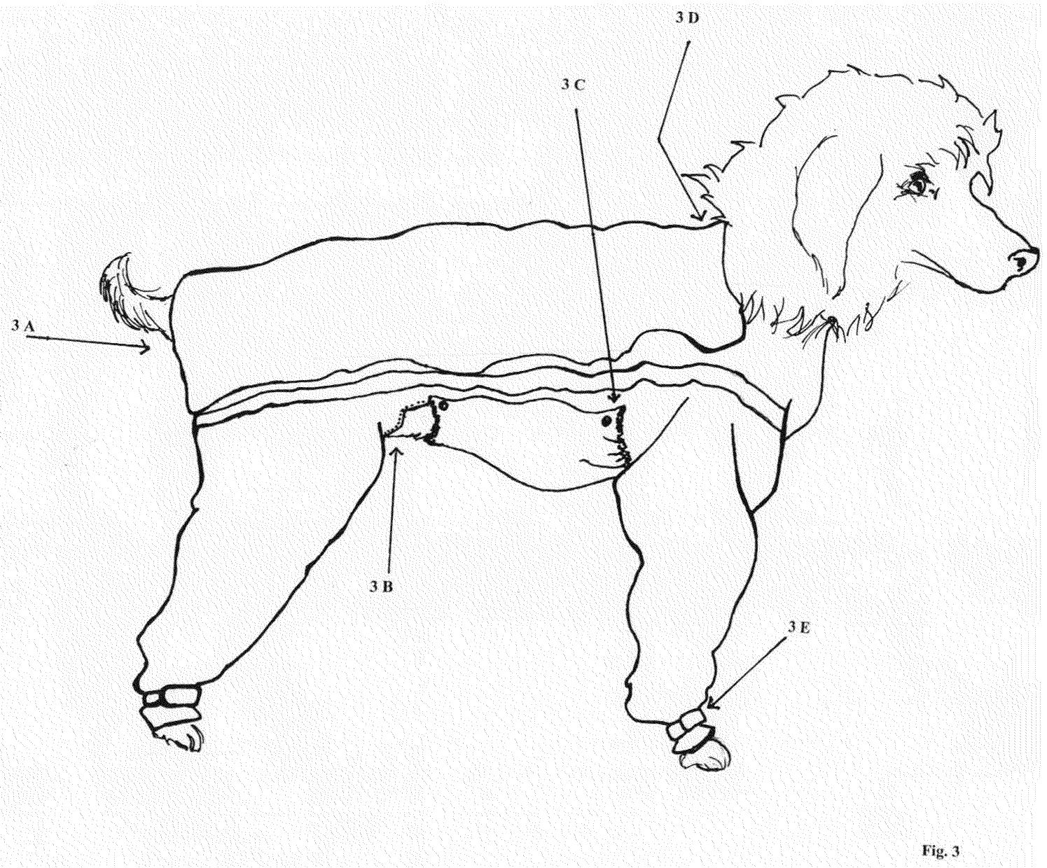

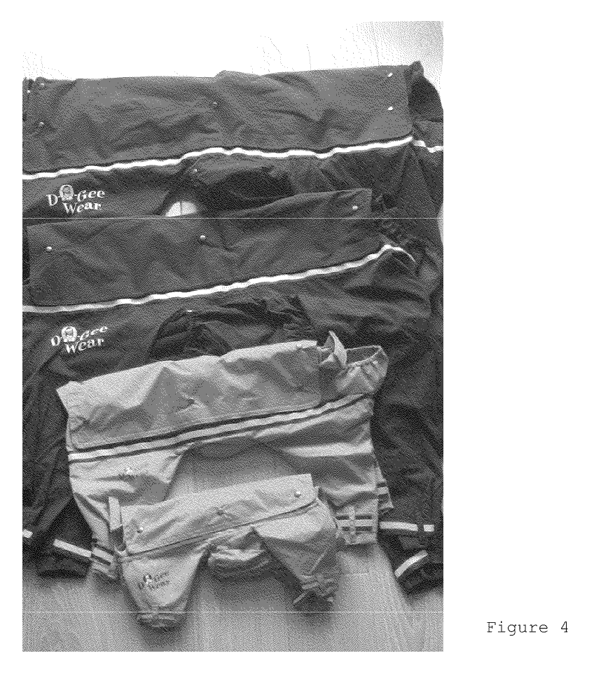

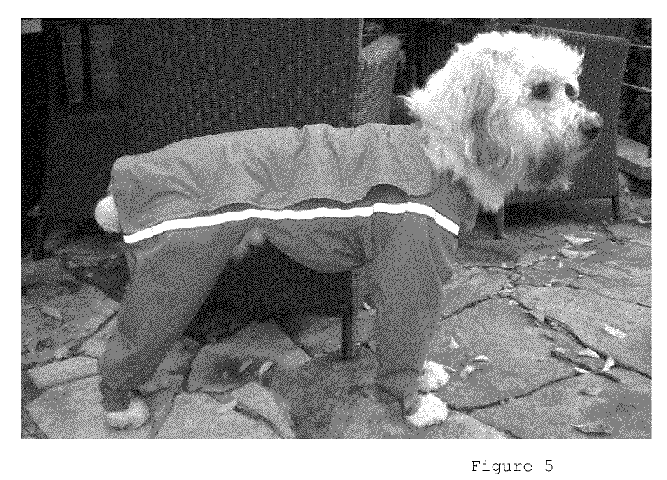

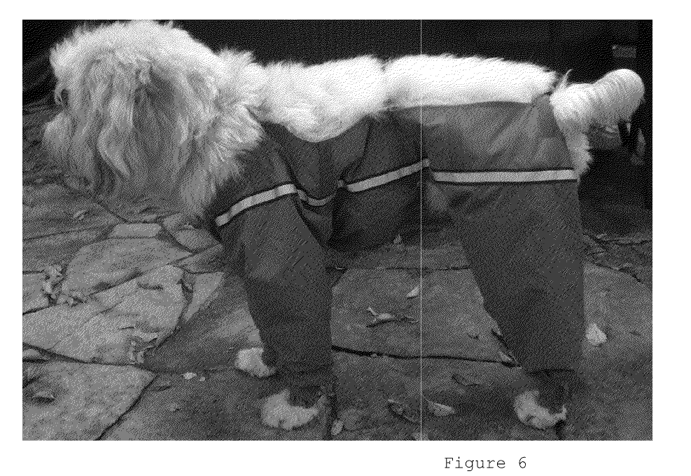

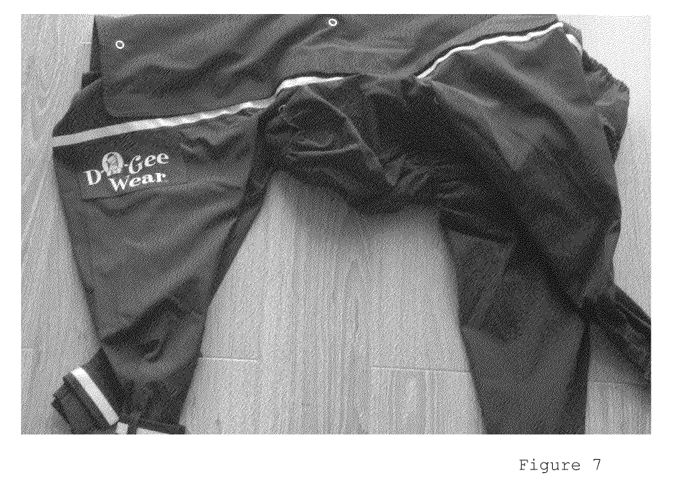

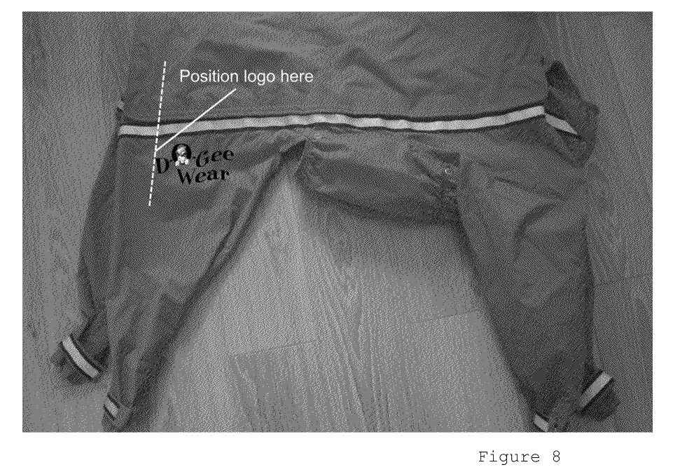

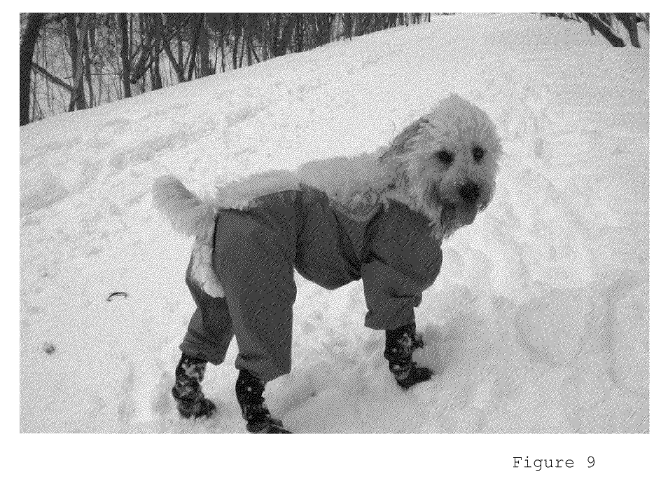

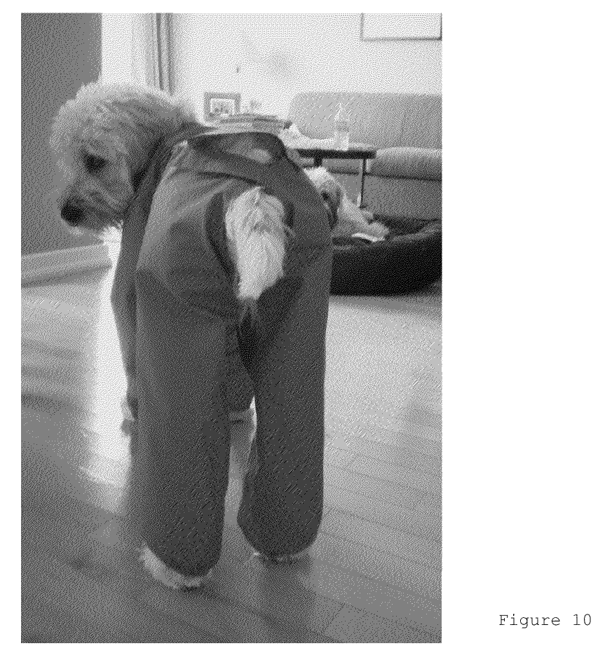

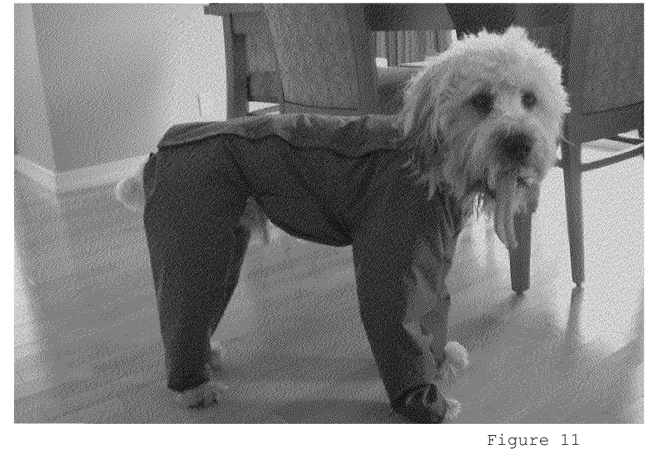

What is claimed is:

1. An configurable protective animal garment for use on an animal having a head, a neck, a chest, a body, front legs and hind quarters, the animal garment comprising: a front portion and a neck portion, the front and the neck portions positionable in surrounding relation to the neck of the animal defining an opening adapted to receive the animal head therethrough; a first side portion and an opposing second side portion extending rearward from the front portion and the neck portion positionable adjacent to the animal body; a first sealable flap means extending from the neck portion rearward towards the animals hind quarters across the body; a front and rear leg portions attached to the formed protective animal garment for inserting the front legs and hind quarters, openings at the base of said front and real leg portions wherein a second sealable flap Means wraps said front legs and hind quarters in a manner to avoid obstructing animal movement, elastic which gathers the animal garment around the chest and the body, at or near the animal genitalia, and at said defined opening to receive the animal head.

2. The configurable protective animal garment in claim 2, wherein said first and second sealable flap means is selected from the group consisting of velcro, buttons, buckles and zippers.

3. The configurable protective animal garment in claim 3, wherein the protective animal garment has a reflective coating running the length of the animal garment to improve visibility.

4. An configurable protective animal garment for use on an animal having a head, a neck, a chest, a body, front legs and hind quarters, the animal garment comprising: a front portion and a neck portion, the front and the neck portions positionable in surrounding relation to the neck of the animal defining an opening adapted to receive the animal head therethrough; a first side portion and an opposing second side portion extending rearward from the front portion and the neck portion positionable adjacent to the animal body; three ore more sealable straps means extending across the top portion of said body from the neck portion rearward towards the animals hind quarters across the body capable of securing the hind quarters, chest and head of an animal; a front and rear leg portions attached to the formed protective animal garment for inserting the front legs and hind quarters, openings at the base of said front and real leg portions wherein a sealable flap means wraps said front legs and hind quarters in a manner to avoid obstructing animal movement, elastic which gathers the animal garment around the chest and the body, at or near the animal genitalia, and at said defined opening to receive the animal head.

5. The configurable protective animal garment in claim 4, wherein said sealable strap means is selected from the group consisting of velcro, buttons, buckles and zippers.

6. The configurable protective animal garment of claim 5, wherein the protective animal garment has a reflective coating running the length of the animal garment to improve visibility.

7. The configurable protective animal garment in claim 4, wherein said sealable flap means is selected from the group consisting of velcro, buttons, buckles and zippers.

8. The configurable protective animal garment in claim 7, wherein the protective animal garment has a reflective coating running the length of the animal garment to improve visibility.

9. The configurable protective animal garment in claim 5, wherein said sealable flap means is selected from the group consisting of velcro, buttons, buckles and zippers.

10. The configurable protective animal garment in claim 9, wherein the protective animal garment has a reflective coating running the length of the animal garment to improve visibility.
